(19) United States
(12) Patent Application Publication
(10) Pub. No.: US 2023/0327138 A1
(43) Pub. Date: Oct. 12, 2023

(54) ENZYMATIC AND DEALLOYED PLATINUM HONEYCOMB SYSTEM

(71) Applicant: AstraCell LLC, Suwanee, GA (US)

(72) Inventors: Ishan MAHAJAN, Duluth, GA (US); Varnica BASAVARAJ, Suwanee, GA (US); Sarvesh PRABHU, Suwanee, GA (US); Srirag TATAVARTI, Suwanee, GA (US)

(21) Appl. No.: 18/298,308

(22) Filed: Apr. 10, 2023

Related U.S. Application Data
(60) Provisional application No. 63/329,226, filed on Apr. 8, 2022.

(51) Int. Cl. H01M 4/92; H01M 8/1004; H01M 8/1039

(52) U.S. Cl. CPC H01M 4/926; H01M 8/1004; H01M 2004/8694; H01M 8/1039; H01M 4/921

(57) ABSTRACT

Techniques for improving fuel cells are presented herein. An electrochemical fuel cell, in accordance with an aspect of the present disclosure comprises bipolar plate layers comprising an anode plate and a cathode plate; a fuel supply to the anode plate; an oxidant supply to the cathode plate; gas diffusion layers proximate to a respective bipolar plate layer; an electrolyte membrane layer; a graphite honeycomb structure positioned between a gas diffusion layer and the electrolyte membrane layer; and a de-alloyed platinum with immobilized enzymes coupled to the graphite honeycomb structure.

### CROSS-REFERENCE TO RELATED APPLICATIONS

This application claims priority to U.S. Provisional Patent Application No. 63/329,226 titled “ENZYMATIC AND DEALLOYED PLATINUM HONEYCOMB SYSTEM”, filed Apr. 8, 2022, the disclosure of which is hereby incorporated by reference in its entirety.

### FIELD OF THE INVENTION

The present invention relates generally to fuel cell technology, and more specifically to incorporating an enzyme catalyst system with a honeycomb design in a hydrogen fuel cell.

### BACKGROUND OF THE INVENTION

Generally, electrochemical devices such as fuel cells are electrochemical devices that generate and/or store electrical energy. While both batteries and fuel cells generate power through an internal chemical reaction, a fuel cell differs from a battery in that it uses an external supply that continuously replenishes the reactants in the fuel cell. By contrast, a battery has a fixed internal supply of reactants. The fuel cell can supply power continuously as long as the reactants are replenished, whereas a battery can only generate limited power before it must be recharged or replaced. This has made fuel cells a popular choice for space applications to deliver crew and cargo to space. In recent years, there have been significant advances in the development of Proton Exchange Membrane (PEM) fuel cells using hydrogen and air as the fuel and oxidant for transportation applications.

Accordingly, a fuel cell is an electrochemical device which reacts hydrogen, a fuel source, and oxygen to produce electricity, water, and heat. The basic process is highly efficient and fuel cells are environmentally friendly since fuel cells fueled by the pure hydrogen produce virtually no pollution. In addition, since fuel cells may be assembled into various arrangements, power systems have been developed to produce a wide range of electrical power outputs. As a result, fuel cell power systems may be an environmentally conscious and valuable source of electricity for a wide variety of applications.

A well known fuel cell technology is the proton exchange membrane fuel cell (PEMFC). The electrochemical process under which PEMFC operate is understood in the art. A typical single PEMFC produces a useful voltage of roughly 0.45 to 0.70 volts DC. However, most fuel cells are operated at approximately 0.60 volts DC in order to extract the greatest efficiency. To achieve a useful voltage, a number of individual PEMFCs are electrically combined or coupled in series. For example, in a common configuration, a number of individual fuel cells are electrically coupled in series to form a fuel cell stack. In a fuel cell stack configuration, the anode or one fuel cell is electrically coupled to the cathode of another fuel cell to connect the two fuel cells in series. It should be noted that any number of fuel cells may be similarly stacked together to achieve the desired output voltage and current.

In another fuel cell arrangement, fuel cell stacks are provided wherein the individual fuel cells are separated by an electrically conductive bipolar separator plate. Further, the individual fuel cells are placed between two end plates, and a substantial compressive force is applied to the individual fuel cell positioned between the end plates to effectively seal the structure to prevent leakage of the gas and to achieve an operably effective ohmic electrical connection between the respective fuel cells.

While traditional PEMFC stacks have operated with some degree of success, a number of shortcomings continue to distract from their usefulness. First among these shortcomings is the high cost of manufacture for the individual components of a traditional stack design. Among these high cost components is the bipolar plate which is employed with same. In order to save costs, many manufacturers of fuel cell stacks have attempted to combine a number of functions into the bipolar plate. A modern bipolar plate is a precisely fabricated component that performs a number of functions including fuel management, cooling, electrical conduction, and gas separation.

Another primary cost or factor which impacts a traditional fuel cell stack is attributed to the force compression needed to make such devices operational. In order to achieve an operationally effective electrical conductivity between a proton exchange membrane, a gas diffusion layer, and/or a bipolar plate, a great deal of force must be applied between the end plates of the traditional stack. Typically, these compression forces are in excess of 100 pounds per square inch. To achieve this level of compressive force, costly, heavy, and complex components are often required. The application of this force typically compresses same components within a stack, for those components which are porous, this same force may reduce the porosity of same. Yet another shortcoming attributable to the traditional fuel cell stack design or arrangement is heat management. Because a fuel cell generates heat while generating electricity, excess heat is often created and accumulates in the center and other locations within the stack. A number of sophisticated technologies and designs have been developed to manage these hotspots, but the result has been higher manufacturing costs and greater complexity for a resulting fuel cell stack system.

There is an increasing need to use fuel cells to power spacecraft designs, including for scientific exploration. Currently, spacecraft designs favor the use of PEMFCs to power their flight through space. PEMFCs use platinum as a catalyst, use Nafion as an electrolyte membrane, and have gas diffusion layers. Platinum is the only metal catalyst that can withstand the varying temperature and acidic conditions of fuel cells in space. However, platinum is expensive to mine, purify, and use. Additionally the demand for traditional PEMFC fuel cells is skyrocketing, which is rapidly leading to more extraction of platinum from the earth. Furthermore, PEMFC cells have a risk of ruptures, weld failure, and corrosion, due to the comparatively high temperatures at which they operate. Accordingly, there is a need for an improvement over existing fuel cell designs.

### SUMMARY OF THE INVENTION

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

The present invention is directed to a fuel cell, incorporating an additional honeycomb layer, which boosts the efficiency of the fuel cell, decreases the need for platinum, and is safer and more environmentally friendly than traditional fuel cells. An aspect of the subject matter described in this disclosure can be implemented in an electrochemical fuel cell comprising: bipolar plate layers comprising an anode plate and a cathode plate; a fuel supply to the anode plate; an oxidant supply to the cathode plate; gas diffusion layers proximate to a respective bipolar plate layer; an electrolyte membrane layer; a graphite honeycomb structure positioned between a gas diffusion layer and the electrolyte membrane layer; and a de-alloyed platinum with immobilized enzymes coupled to the graphite honeycomb structure.

Another further aspect of the subject matter described in this disclosure can be implemented in a catalyst layer comprising a graphite honeycomb structure positioned between a gas diffusion layer and an electrolyte membrane layer; and a de-alloyed platinum with immobilized enzymes coupled to the graphite honeycomb structure.

Yet a further aspect of the subject matter described in this disclosure can be implemented in a system comprising: bipolar plate layers comprising an anode plate and a cathode plate; a fuel supply to the anode plate; an oxidant supply to the cathode plate; gas diffusion layers proximate to a respective bipolar plate layer; an electrolyte membrane layer; a graphite honeycomb structure positioned between a gas diffusion layer and the electrolyte membrane layer; and a de-alloyed platinum with immobilized enzymes coupled to the graphite honeycomb structure.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 is a diagram illustrating a proton exchange membrane (PEM) fuel cell stack according to an embodiment of the present invention.

FIG. 2 is an exploded, perspective view of a hydrogen fuel cell according to an embodiment of the present invention.

FIG. 3 is a side view of a honeycomb structure according to an embodiment of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of exemplary embodiments according to the present disclosure will now be presented with reference to various systems and methods. These systems and methods will be described in the following detailed description and illustrated in the accompanying drawings by various blocks, components, circuits, processes, algorithms, etc. (collectively referred to as “elements”).

Fuel cells are electrochemical cells that use the chemical energy of hydrogen (or other fuels) to cleanly and efficiently produce electricity. Fuel cells are attractive electrical power sources, due to their higher energy efficiency and environmentally compatibility compared to an internal combustion engine. In contrast to batteries, which must be recharged, electrical energy from fuel cells may be produced as long as the fuels (e.g., methanol or hydrogen) and oxidant are supplied. Thus, there is a need in the design of improved fuel cells to fill future energy needs.

Generally, fuel cell apparatus include a solid oxide fuel cell apparatus using solid oxide fuel cell apparatus using solid electrolyte. The solid oxide fuel cell apparatus includes a fuel cell stack in which a large number of fuel cells may be stacked together. Each of the fuel cells is configured such that a cathode and an anode are provided on respective opposite sides of a plate-shaped solid electrolyte. Air is supplied to the cathode and fuel gas is supplied to the anode. The fuel gas and oxygen contained in air then react chemically with each other via the solid electrolyte, thereby generating electricity. The solid oxide fuel cell apparatus also includes current collectors which are in contact with respective anode and cathode electrically for establishing electrical communication among the fuel cells.

Fuel cell stacks may be either internally or externally manifolded for fuel and air. In internally manifolded stacks, the fuel and air is distributed to each cell using risers contained within the stack. In other words, the gas flows through riser openings or holes in the supporting layer of each cell, such as the electrolyte layer. In externally manifolded stacks, the stack is open on the fuel and air inlet and outlet sides, and the fuel and air are introduced and collected independently of the stack hardware. For example, the inlet and outlet fuel and air flow in separate channels between the stack and the manifold housing in which the stack is located.

Proton exchange membrane fuel cells (PEMFC), also known as polymer electrolyte membrane (PEM) fuel cells, are a type of fuel cell developed mainly for transportation, stationary fuel-cell and portable fuel-cell applications. PEMFCs are considered to be one of the most versatile type of fuel cells currently in production and produce the most power for a given weight or volume of fuel cell. Because they are lightweight, have such high power-density, and cold-start capability, PEMFCs may be used in many applications such as stationary combined-heat-power, transport, portable power, and even applications in space.

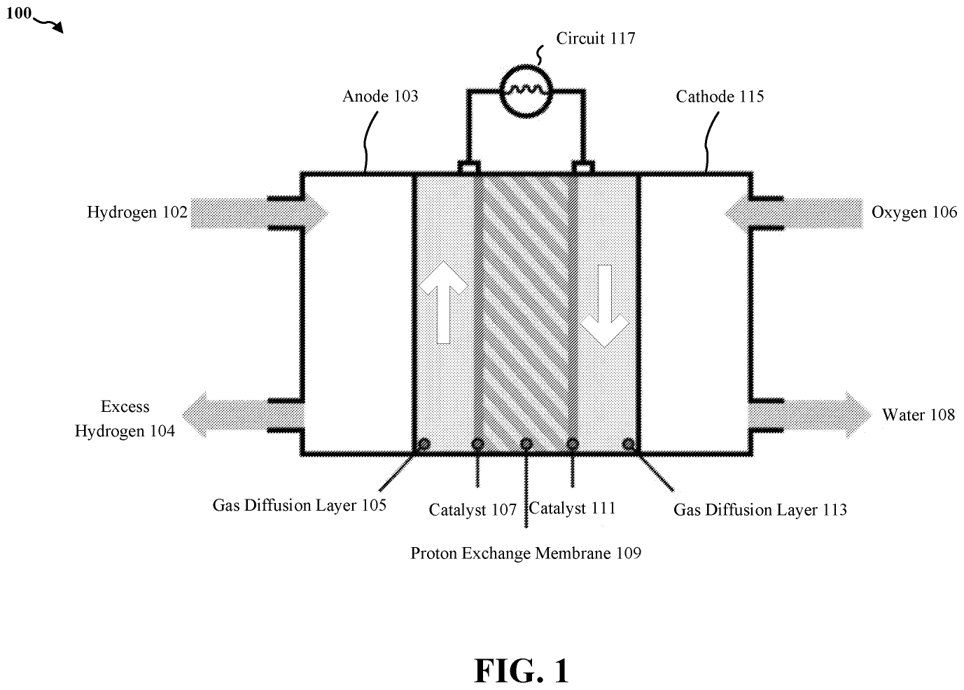

FIG. 1 is a diagram illustrating a system 100 illustrating a PEMFC stack according to an embodiment of the present invention. In this example, the system 100 comprises an anode 103, a gas diffusion layers (GDL) 105, 113, catalysts 107, 111, a proton exchange membrane 109, a cathode 115, and an external circuit 117. PEMFC uses a water-based, acidic polymer membrane as its electrolyte with platinum-based electrodes. PEMFC cells operate at relatively lower temperatures (below 100° C.) and can tailor electrical output to meet dynamic power requirements. Due to the relatively low temperatures and use of precious metal-based electrodes, these cells operate on pure hydrogen 102.

The main components of a PEMFC are the gas diffusion layer, membrane, and catalyst. GDLs 105 are commercially available in various forms such as carbon paper or woven carbon fabric. The GDLs 105 are placed on either side of the proton exchange membrane 109 in the fuel cell. A GDL allows the flow or reactant gases hydrogen 102, air/oxygen 106, and product gases to pass through it. The water 108 formed in a cell should not choke the pores of this paper or fabric and so they are pre-coated with polytetrafluoroethylene (PTEF), which changes the GDL material from hydrophilic to hydrophobic. PTFE is also commonly known as Teflon. The platinum catalysts for both the anode 103 and cathode 115 can be coated on the surface of a GDL 105. The hydrogen 102 or oxygen 106 reacts in three phases: interface-gas phase (hydrogen or oxygen), liquid phase (water) and solid phase (catalyst). The carbon paper or fabric serves as a structural support for the electrocatalyst layer as well as current collector.

Hydrogen fuel 102 is processed at the anode 103 where electrons are separated from protons on the surface of a platinum-based catalyst 107. The protons pass through the proton exchange membrane 109 to the cathode 115 side of the cell while the electrons travel in an external circuit 117, generating the electrical output of the cell. On the cathode 115 side, another precious metal electrode combines the protons and electrons with oxygen 106 to produce water 108, which is expelled as the only waste product. The oxygen 106 may either be provided in a purified form, or extracted at the electrode directly from the air.

The main components of a PEMFC are the GDL 105, the proton exchange membrane 109, and catalyst 107, 111. Gas diffusion layers (GDLs) are commercially available in various forms such as carbon paper or woven carbon fabric. The GDLs are placed on either side of the membrane in the fuel cell. A GDL allows the flow or reactant gases H₂, air/oxygen, and product gases to pass through it. The water formed in a cell should not choke the pores of this paper or fabric and so they are pre-coated with polytetrafluoroethylene (PTEF), which changes the GDL material from hydrophilic to hydrophobic. PTFE is also commonly known as Teflon. The platinum catalysts for both the anode and cathode side can be coated on the surface of a GDL. The hydrogen or oxygen reacts in three phases: interface-gas phase (hydrogen or oxygen), liquid phase (water) and solid phase (catalyst). The carbon paper or fabric serves as a structural support for the electrocatalyst layer as well as current collector.

As shown in FIG. 1, a fuel, such as hydrogen fuel 102, is fed into the anode 103 and a metal catalyst 107 oxidizes the hydrogen gas into protons and electrons. The only emission when hydrogen 102 is used as a fuel is air and water 108. In fuel cells, the electrode assemblies of both the anode 103 and the cathode 115 contain a metal catalyst (e.g., platinum) 107, 111 supported by a conductive material. Some PEMFC use a GDL 105, 113 on both electrodes to help distribute gases evenly across the electrode surfaces. Fuel cells use an electrolyte between the cathode 115 and the anode 103. Fuel cells that employ proton conducting electrolyte membranes are referred to as PEMFC. Reactions take place where the electrolyte, gas, and an electrode are in contact with one another. The protons are then transferred through the electrolyte material to the cathode 115, while the electrons are conducted through an external circuit (from the anode 103) to the cathode 115 via an electrically conductive material. At the cathode 115, an oxidant, such as oxygen 106, diffuses through the electrode where it reacts with the electrons and protons to form water 108. The operation of PEMFC produces electricity, water, and heat.

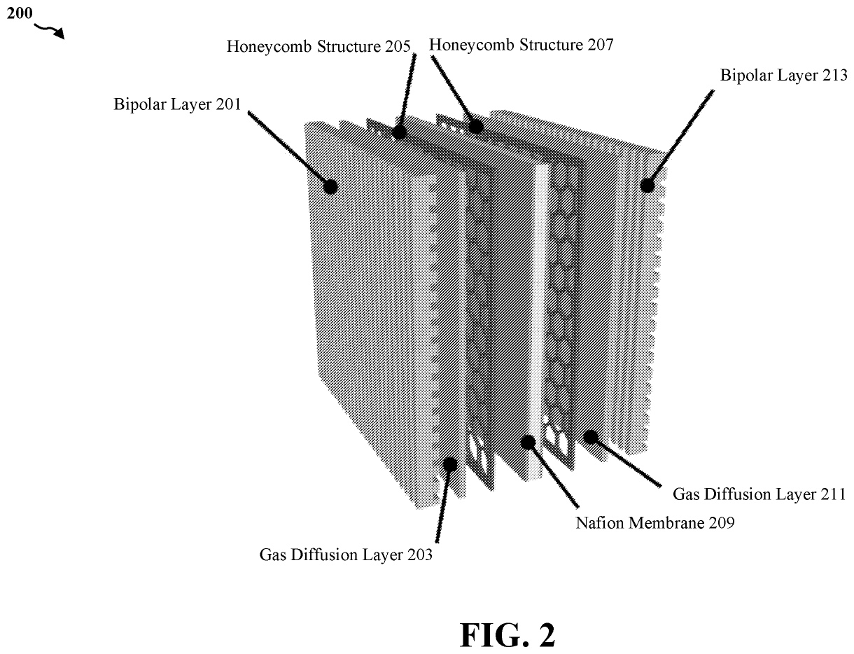

FIG. 2 is an exploded, perspective view of a hydrogen fuel cell 200 according to an embodiment of the present invention. In this example, the hydrogen fuel cell 200 comprises: an electrolyte membrane (e.g., a Nafion membrane 209), gas diffusion layers 203, 211, a glucose oxidase-catalyzed anode and a laccase-catalyzed cathode, and bipolar plates 201, 213. In addition, both electrodes (e.g., the glucose oxidase-catalyzed anode and the laccase-catalyzed cathode) utilize a carbon nano-tube inspired honeycomb structure 205, 207 to increase enzyme reaction surface area, which would make the rate of energy production more efficient with less degradation.

Unlike the PEMFC shown in FIG. 1, the hydrogen fuel cell 200 uses de-alloyed platinum in conjunction with immobilized enzymes in a graphite honeycomb structure 205 as the catalyst for the fuel cell. In some examples, the de-alloyed platinum may be a platinum alloyed with a transitional metal such as nickel or iron. By alloying platinum with these metals, the amount of platinum may be reduced and addresses issues present at the cathode with oxygen reduction reactions. In addition, the hydrogen fuel cell uses a type of platinum that is altered to refine the catalytic properties of platinum to make it a more efficient catalyst. As the catalyst is more efficient, the hydrogen fuel cell 200 may contain less platinum in its fuel cell as compared to the PEMFC system 100 shown in FIG. 1. The reduction in platinum also reduces the overall manufacturing cost of the hydrogen fuel cell 200 since platinum is extremely expensive to manufacture.

The hydrogen fuel cell 200 uses immobilized enzymes known as glucose oxidase and laccase to create a nano biohybrid catalyst. In particular, glucose oxidase is used at the anode and laccase will be used at the cathode. Using these immobilized enzymes is advantageous since they are much cheaper than platinum, can be produced in mass, and, in the right conditions, can produce more energy as compared with just using platinum.

In some examples, a 100 micron Nafion electrolyte membrane 209 will be utilized at the center of an individual cell to mediate hydrogen ion movement from the anode to the cathode. Furthermore, a 410-micron wet-proofed carbon cloth may be used as the gas diffusion layers 203 to help carry gases to the electrode and remove waste water.

The catalyst in fuel cells power the reactions that allow for the inputted hydrogen and oxygen to produce electricity and water. Catalysts are found at the anode and cathode of duel cells. At the anode side of the fuel cell, a catalyst facilitates a reduction reaction where the inputted hydrogen gas (H₂) is reduced to protons and electrons. The electrons then flow through the external circuit to produce electricity while the protons flow through the Nafion electrolyte to the cathode. At the cathode side of the fuel cell, a catalyst facilitates an oxidation reaction where the inputted oxygen gas (O₂) is oxidized in combination with the protons and electrons to create water molecules (H₂O), which will be managed by the gas diffusion layers 203, 211 and bipolar plates 201, 213.

Platinum is a main catalyst that is used in fuel cells for space travel as it is the most efficient metal catalyst for speeding up chemical reactions. Additionally, platinum is the only metal catalyst that can withstand the varying temperature and acidic conditions of fuel cells in space. Though platinum is an effective catalyst, it is extremely expensive to mine, purify, and use. For these reasons, platinum contributes greatly to the enormous costs of current fuel cells, since platinum catalyst currently account for almost 20% of the cost of the total cell. Thus, reducing the cost of the catalyst is important for the future of fuel cells as the high cost is restrictive.

The electrolyte membrane, catalyst electrode layers, and GDLs make up a single cell, or membrane electrode assembly (MEA). To connect multiple MEAS in a stack, bipolar plates 201, 213 are needed. The bipolar plates 201, 213 connect individual fuel cells in a stack with the needed voltage by connecting the anode of one cell to the cathode of the next. Furthermore, ingrained flow field patterns within the bipolar plates will help input hydrogen and oxygen gas, distribute the gases uniformly across the surface area of the GDLs in the MEAs, and aid in temperature management.

In some examples, the bipolar plates 201, 213 facilitate water removal from the overall fuel stack and are often attached to the outer fuel cell shell to clamp the cells together in a cohesive stack. The bipolar plates 201, 213 allow the fuel cell stack to remove the pure water from the system, and the water can be used for consumption. In addition, due to its multiple functions, bipolar plates 201, 213 are chemically inert, resistant to corrosion, impervious to gases, and are electrically and thermally conductive. The bipolar plates 201, 213 are often the thickest, heaviest, and most voluminous parts of the fuel cell stack. Many metals, such as aluminum, steel, and titanium, can be used for the bipolar plates 201, 213. In some examples, graphite is used for the bipolar plates since graphite is durable, corrosion-resistant, and highly conductive. The bipolar plate may be etched using a machine or electrochemically in a pattern to create an efficient flow field for the fuel cell. In some examples, the flow field pattern corresponds to a serpentine flow field pattern since the serpentine flow field pattern can effectively distribute gases throughout the cell. In addition, automated robots may easily etch the serpentine flow field pattern design into the bipolar plates at manufacturing plants.

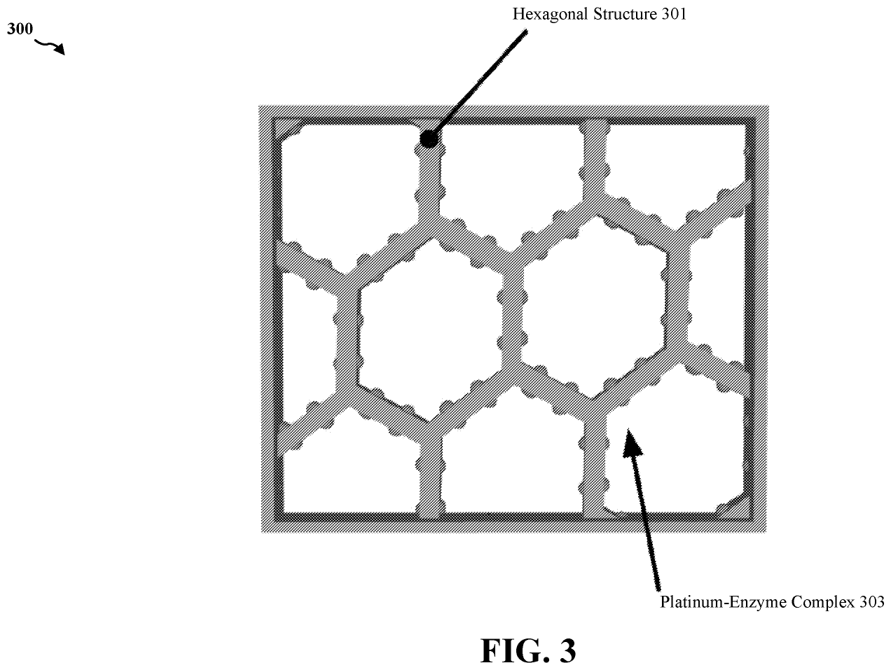

FIG. 3 is a side view of a honeycomb structure 300 according to an embodiment of the present invention. The honeycomb structure will be made out of a three-dimensional (3-D) graphite in a hexagonal structure 301. Graphite is a two-dimensional carbon-based nanomaterial and may be utilized in an enzyme immobilization platform due to its large specific surface area, high electronic conductivity, biocompatibility, and high chemical stability. In addition, the honeycomb structure eliminates many of the issues that arise when using an enzyme as a catalyst and may maximize the reactions in the fuel cell. However, a modification may be made to the graphite honeycomb structure since the cathode, where more platinum is needed, is prone to leaching of core transition metal atoms to the surface of the nano particles into the electrolyte membrane as the catalyst is cycled. Therefore, the honeycomb structure may be modified in a way that the core metals will remain in the catalyst layer.

The hydrogen fuel cell 200 reduces the cost of catalysts by using immobilized enzymes such as glucose oxidase and laccase in conjunction with de-alloyed platinum to create a platinum-enzyme complex that is both cost-effective and energy efficient. When platinum is de-alloyed, the catalytic properties of platinum are magnified to generate the best possible catalyst. These types of enzymes will have the same function as platinum as glucose oxidase will be present at the anode and conduct reduction reactions while laccase will be present at the cathode and conduct oxidation reactions. Thus, using enzymes as catalyst proves to be effective in reducing costs since enzymes can be easily mass replicated within a lab, which greatly lowers costs. Moreover, since enzymes may be as efficient as platinum catalysts, the amount of platinum used within the hydrogen fuel cell 200 may be greatly reduced.

The honeycomb structure 300 will be utilized in order to better stabilize the platinum-enzyme catalysts 303 in the electrodes and further increase energy production rates. As shown in FIG. 3, the honeycomb structure is a hexagonal lattice that is made from 3-D graphite. By immobilizing the platinum and enzymes, the oxidation and reduction reactions will be more stabilized, which allows energy to be produced more easily with less long-term deterioration. Furthermore, compared to a free-floating enzymatic solution in the electrodes, the honeycomb fuel cell will increase the reaction surface area, raising the likelihood for effective collisions between the catalysts and their substrates.

In some examples, the honeycomb structure 300 may be modified slightly in the cathode layer so platinum, which exists in higher concentration in the cathode, will remain immobilized and not contaminate the Nafion electrolyte layer. The hexagonal structure 301 of the honeycomb structure allows the cells to be smaller with fewer catalysts because the honeycomb structure will multiply the rate at which catalysts can create electricity without harming their lifespan.

The use of platinum-enzyme complexes immobilized on graphite honeycomb structure as well as efficient materials like Nafion electrolyte and carbon-based GDL and bipolar plates lead to highly efficient and productive power output. Since each MEA is roughly 50 cm×50 cm, each cell may produce approximately 225 watts at 0.34 V. In some examples, 54 MEAs will be layered with bipolar plates into a single fuel cell stack that produces roughly 12.15 kW of continuous energy.

The hydrogen fuel cell with de-alloyed platinum in conjunction with immobilized enzymes in a graphite honeycomb structure may also operate at a significantly higher rate than traditional fuel cells. For example, the honeycomb structure may perform optimally at temperatures as low as 50° C. while still being efficient. This also makes the honeycomb structure safer than PEMFC cells due to removed risk of ruptures, welding failures, and corrosion caused by high heat. The lowered temperature also allows for a slower degradation process, which increases the life of a honeycomb system to an estimated 10,000+ hours. Furthermore, the hydrogen fuel cell with de-alloyed platinum in conjunction with immobilized enzymes in a graphite honeycomb structure may reduce hydrogen and oxygen by approximately 25% and replaces large amounts of platinum with enzymes.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for fuel cells and fuel cell components. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phase “step for.”

What is claimed is:

1. An electrochemical fuel cell, comprising:
bipolar plate layers comprising an anode plate and a cathode plate;
a fuel supply to the anode plate;
an oxidant supply to the cathode plate;
gas diffusion layers proximate to a respective bipolar plate layer;
an electrolyte membrane layer;
a graphite honeycomb structure positioned between a gas diffusion layer and the electrolyte membrane layer; and
a de-alloyed platinum with immobilized enzymes coupled to the graphite honeycomb structure.

2. The electrochemical fuel cell of claim 1, wherein the graphite honeycomb structure comprises a hexagonal lattice.

3. The electrochemical fuel cell of claim 1, wherein the graphite honeycomb structure comprises a three-dimensional graphite.

4. The electrochemical fuel cell of claim 1, wherein the de-alloyed platinum is platinum alloyed with a transitional metal.

5. The electrochemical fuel cell of claim 1, wherein the immobilized enzymes comprises a glucose oxidase-catalyzed present at the anode plate and a laccase-catalyzed cathode present at the cathode plate.

6. The electrochemical fuel cell of claim 1, wherein platinum remains immobilized in the cathode to not contaminate the electrolyte membrane layer.

7. The electrochemical fuel cell of claim 1, wherein the bipolar plate layers correspond to a graphite plate.

8. The electrochemical fuel cell of claim 1, wherein the bipolar plate layers are ingrained with a flow field pattern to distribute gases uniformly across a surface area of the gas diffusion layers.

9. The electrochemical fuel cell of claim 8, wherein the flow field pattern corresponds to a serpentine flow field pattern.

10. The electrochemical fuel cell of claim 8, wherein the flow field pattern corresponds to a parallel pattern.

11. The electrochemical fuel cell of claim 1, wherein the electrolyte membrane layer comprises Nafion.

12. A catalyst layer, comprising:
a graphite honeycomb structure positioned between a gas diffusion layer and an electrolyte membrane layer; and
a de-alloyed platinum with immobilized enzymes coupled to the graphite honeycomb structure.

13. The catalyst layer of claim 12, wherein the graphite honeycomb structure comprises a hexagonal lattice.

14. The catalyst layer of claim 12, wherein the de-alloyed platinum is platinum alloyed with a transitional metal.

15. The catalyst layer of claim 12, wherein the immobilized enzymes comprises a glucose oxidase-catalyzed present at an anode plate and a laccase-catalyzed cathode present at a cathode plate.

16. A system, comprising:
bipolar plate layers comprising an anode plate and a cathode plate;
a fuel supply to the anode plate;
an oxidant supply to the cathode plate;
gas diffusion layers proximate to a respective bipolar plate layer;
an electrolyte membrane layer;
a graphite honeycomb structure positioned between a gas diffusion layer and the electrolyte membrane layer; and
a de-alloyed platinum with immobilized enzymes coupled to the graphite honeycomb structure.

17. The system of claim 16, wherein the graphite honeycomb structure comprises a hexagonal lattice.

18. The system of claim 16, wherein the graphite honeycomb structure comprises a three-dimensional graphite.

19. The system of claim 16, wherein the de-alloyed platinum is platinum alloyed with a transitional metal.

20. The system of claim 16, wherein the immobilized enzymes comprises a glucose oxidase-catalyzed present at the anode plate and a laccase-catalyzed cathode present at the cathode plate.
